(19) United States
(12) Patent Application Publication
(10) Pub. No.: US 2012/0275084 A1
(43) Pub. Date: Nov. 1, 2012

(54) COMMUNICATIONS DISTRIBUTION SYSTEMS, APPARATUS AND METHODS USING POWER LINE CARRIER COMMUNICATIONS

(75) Inventors: Yakov Lvovich Familiant, Brown Deer, WI (US); Luis Rafael Pereira, Menomonee Falls, WI (US); Pradeepkumar Gokuldasji Bhutada, Nerul (IN)

(73) Assignee: Eaton Corporation

(21) Appl. No.: 13/098,037

(22) Filed: Apr. 29, 2011

(51) Int. Cl. H02B 1/00

(52) U.S. Cl. 361/601

(57) ABSTRACT

A sensor communications distribution system for a data center or other distributed electronic installation includes a plurality of communications distribution units mounted in a plurality of equipment racks. Each of the communications distribution units comprising a frame configured to be mounted in an equipment rack, a power bus supported by the frame and coupled to a power distribution network and a power line carrier communications interface circuit coupled to the power bus and to a plurality of external sensors (e.g., via connectors and/or wirelessly). Power may be provided to the sensors and/or to equipment in the racks from the communications distribution units.

### BACKGROUND

The inventive subject matter relates to power and communications distribution and, more particularly, to communications and power distribution for large scale electronic systems, such as data centers and telecommunications installations.

Large-scale distributed electronic installations, such as data centers and telecommunications switching centers, typically include multiple equipment racks that house modular electronic equipment units, such as servers, routers, switches, storage devices and the like. A typical data center includes a power distribution network that is used to provide power to the equipment racks. The power distribution system may include one or more utility feeds, one or more generator feeds and one or more uninterruptible power supply (UPS) which may be used to provide backup power. These power sources may be connected to distribution equipment, such as transfer switches and cabinet-type power distribution units (PDUs) that include breakers that distribute power to plural branch circuits. Equipment racks may be connected to such branch circuits, and may include smaller PDUs (e.g., power strips) mounted therein that are used to provide power connections for individual pieces of equipment. Examples of data center power distribution techniques are described, for example, in U.S. Pat. No. 7,358,439 to Rasmussen et al. and U.S. Pat. No. 7,561,141 to Johnson, Jr.

Data centers also typically include monitoring systems that include various sensors that may be used, for example, to monitor environmental conditions, such as temperature and humidity, and to monitor status of various pieces of equipment, such as the racks themselves or support equipment associated therewith. Such sensors may be positioned in, on or near equipment racks and may be monitored at a central location via a communications network. Such sensor systems are commonly networked using Ethernet cabling.

### SUMMARY OF THE INVENTIVE SUBJECT MATTER

In some embodiments of the inventive subject matter, a sensor communications distribution system includes a plurality of communications distribution units mounted in a plurality of equipment racks. Each of the communications distribution units includes a frame configured to be mounted in an equipment rack, a power bus supported by the frame and coupled to at least one power distribution network and a power line carrier communications interface circuit coupled to a plurality of sensors and to the power bus.

In some embodiments, the communications distribution units may include a plurality of communications bus connectors supported by the frame and coupled to the power line carrier communications interface circuit and to respective ones of the sensors. In some embodiments, each communications distribution unit further includes a power converter circuit coupled to the power bus and configured to provide power to power conductors of the communications bus connectors. Each communications distribution unit may further include a plurality of power connectors supported by the frame, coupled to the power bus and coupled to power inputs of equipment mounted in the equipment racks.

In some embodiments, the power line carrier communications interface circuit is wirelessly coupled to the plurality of sensors. Each communications distribution unit may further include a plurality of power connectors supported by the frame, coupled to the power bus and coupled to power inputs of equipment mounted in the equipment racks.

The system may further include a power line carrier gateway coupled to the at least one power distribution network. The system may also include a monitor device coupled to the power line carrier gateway. In some embodiments, a monitor device may be coupled to a power line carrier communications interface circuit of one of the communications distribution units.

Additional embodiments provide a communications distribution unit including a frame configured to be mounted to an electronic equipment rack, a plurality of communications bus connectors supported by the frame and a power bus supported by the frame and configured to be coupled to at least one power distribution network of the equipment rack. The communications distribution unit further includes a power line carrier communications interface circuit coupled to the plurality of communications bus connectors and to the power bus and a power converter circuit coupled to the power bus and configured to provide power to power conductors of the communications bus connectors.

Still further embodiments provide a power and communications distribution unit including a frame configured to be mounted to an electronic equipment rack, a plurality of power connectors supported by the frame, a power bus supported by the frame and electrically coupled to the plurality of power connectors and a power line carrier communications interface circuit coupled to the power bus and configured to be coupled to external sensors. In some embodiments, the unit may include a plurality of communications bus connectors supported by the frame and the power line carrier communications interface circuit may be configured to be coupled to the external sensors via the plurality of communications bus connectors. The unit may further include a power converter circuit coupled to the power bus and configured to provide power to power conductors of the communications bus connectors. In additional embodiments, the power line carrier communications interface circuit may be configured to be wirelessly coupled to the external sensors.

### BRIEF DESCRIPTION OF THE DRAWINGS

FIG. 1 is a schematic diagram illustrating a communications distribution system according to some embodiments of the inventive subject matter.

FIG. 2 is a schematic of a communications distribution unit according to some embodiments of the inventive subject matter.

FIG. 3 is a schematic diagram illustrating a power and communications distribution system according to some embodiments of the inventive subject matter.

FIG. 4 is a schematic diagram illustrating a power and communications distribution unit according to some embodiments of the inventive subject matter.

FIG. 5 is a plan view of a power and communications distribution unit according to further embodiments of the inventive subject matter.

FIG. 6 is a schematic diagram illustrating a power and communications distribution system according to some embodiments of the inventive subject matter.

FIG. 7 is a schematic diagram illustrating a power and communications distribution system according to further embodiments of the inventive subject matter.

FIG. 8 is a schematic diagram illustrating a power and communications distribution system according to some embodiments of the inventive subject matter.

FIG. 9 is a schematic diagram illustrating a power and communications distribution unit according to some embodiments of the inventive subject matter.

### DETAILED DESCRIPTION OF EMBODIMENTS

Specific embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As will be appreciated by one of skill in the art, the inventive subject matter may be embodied as systems and methods. Some embodiments of the inventive subject matter may include hardware and/or combinations of hardware and software. Some embodiments of the inventive subject matter include circuitry configured to provide functions described herein. It will be appreciated that such circuitry may include analog circuits, digital circuits, and combinations of analog and digital circuits.

Embodiments of the inventive subject matter are described below with reference to block diagrams of systems and methods according to various embodiments of the inventive subject matter. It will be understood that each block of the block diagrams, and combinations of blocks in the block diagrams, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams.

Some embodiments of the inventive subject matter arise from a realization that significant cost savings and efficiency in configuring and maintaining sensor systems in data centers and similar installations may be achieved by using modular communication distribution units that are configured to provide standard interfaces for connection to sensor devices and that consolidate the communications of such sensors by using power line carrier communications over the power distribution network of the data center. In this manner, cabling and other infrastructure needed for sensor communications can be reduced. In further embodiments, such communications distribution units may also provide power to the sensors. In still further embodiments, power and communications distribution units can be used to support sensor communications and power distribution to rack-mounted equipment in environments, such as data and telecommunications centers.

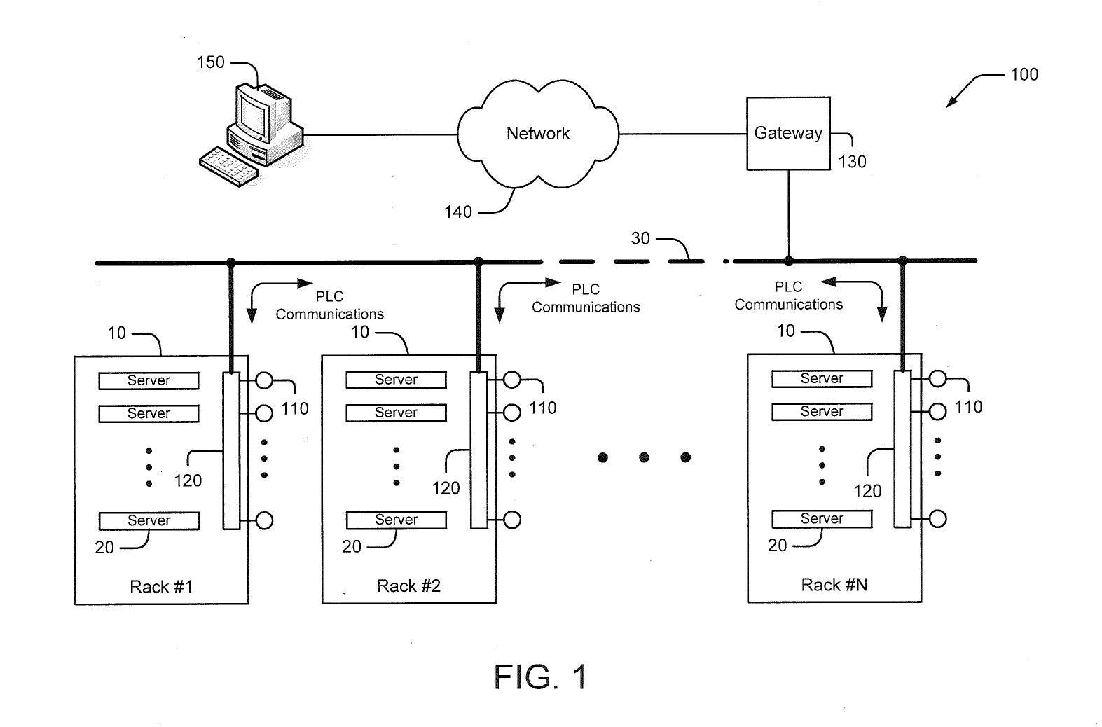

FIG. 1 illustrates a sensor communication system 100 for a data center or similar environment according to some embodiments of the inventive subject matter. The data center includes N equipment racks 10, with each of the equipment racks 10 including a plurality of electronic equipment modules, such as servers 20. It will be appreciated that the racks 10 may include other types of electronic equipment, such as routers, bridges, network switches and the like.

As further illustrated, each of the racks 10 is coupled to a power distribution network 30, which provides power to the servers or other electronic equipment mounted in the racks 10. The power distribution network 30 may take any of a number of forms, including single- and three-phase AC power distribution network components, as commonly used in data centers, or DC power distribution network components, as commonly used in telecommunications centers.

The communications system 100 further includes a plurality of communications distribution units 120, respective ones of which are mounted in respective ones of the equipment racks 10. Each of the communications distribution units 120 is coupled to a plurality of sensors 110. The sensors 110 may be used, for example, to monitor ambient environmental conditions (e.g., temperature, humidity, vibration, airflow, smoke content, etc.). The sensors 110 may also include devices that monitor other items, such as the status of particular components of the data center. For example, the sensors 110 may include sensors that monitor mechanical parameters, such as status of cooling or other equipment associated with the racks 10, and/or status of various components of the racks, such as detection of an open rack door.

The communications distribution units 120 are also coupled to the power distribution network 30. As explained in greater detail below, the communications distribution units 120 may provide an interface between bus communications of the sensors 110 and power line carrier (PLC) communications over the power distribution network 30. For example, as shown in FIG. 1, the communications distribution units 120 may receive sensor data from the sensors 110 over a wireline, optical or other communications bus, such as an Ethernet bus, Universal Serial Bus (USB) or other standardized and/or proprietary communications bus, and may convey this data over the power distribution system 30 to a gateway 130 and on to an application running on a computer 150 via a network 140. The communications distribution units 120 may perform any of a variety of network-related functions, such as routing and network bridging, as well as other communications processing, such as preprocessing and/or consolidation of data received from the sensors 110.

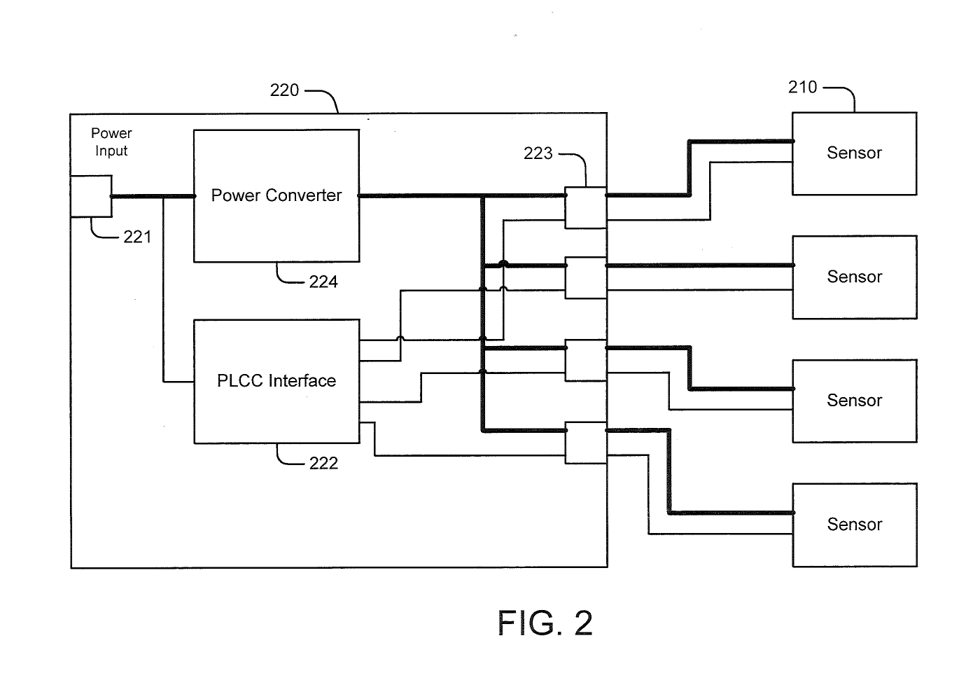

FIG. 2 illustrates a communications distribution unit 220 according to further embodiments of the inventive subject matter. The communications distribution unit 220 includes a power input 221 (e.g., a power cord or similar means for connecting to the power distribution system of a data center) and a plurality of communications bus connectors 223. The communications bus connectors 223 are configured to provide communications bus connections, for example, Ethernet or USB connections, to various sensors 210. It will be appreciated that the bus connectors 223 may be alike or may be a combination of connectors supporting various different communications protocols, such as a combination of Ethernet, USB or other types of standardized connectors and/or proprietary connectors with similar functionality.

The communications distribution unit 220 further includes a power line carrier communications (PLCC) interface circuit 222 that performs conversion between power line carrier communications via the power input 221 and bus communications via the communications bus connectors 223. In particular, the PLCC interface circuit 222 may be configured to receive messages conveyed via powerline carrier over a power distribution network coupled to the power input 221 and responsively transmit corresponding messages over one or more communications busses coupled to the bus connectors 223. The PLCC interface circuit 221 may also be configured to receive messages over or more busses connected to the bus connectors 223 and to responsively transmit power line carrier messages over a power distribution network coupled to the power input 221.

In some embodiments, the PLCC interface circuit 222 may perform a physical layer conversion such that, for example, internet protocol (IP) packets transmitted between the sensors 210 and a user device (e.g., the computer 150 of FIG. 1) may transparently pass through the communications distribution device 220. In further embodiments, the PLCC interface circuit 222 may also provide any of a variety of additional functions. For example, the PLCC interface circuit 222 may perform various networking functions and/or selected on data passing therethrough, such as reformatting, multiplexing or consolidating sensor data received from multiple ones of the sensors 210 for use by a particular end user device, such as a monitoring application program. The PLCC interface circuit 222 may also perform diagnostic functions, such as detecting loss of communications with particular ones of the sensors 210 and responsively communicating status information to an end user device over the power distribution network attached to the power input.

As further illustrated, the communications distribution unit 220 may further include a power converter circuit 224 configured to provide power to at least some of the bus connectors 223 and the connected sensors 210. For example, if the power distribution network coupled to the power input 221 is an AC power distribution network and the bus connectors support powered bus standards, such as power-over-Ethernet (PoE) and/or powered USB, the power converter circuit 224 may include rectifier and/or other power conversion circuitry that generates one ore more appropriate DC power outputs for the bus connectors 223. This can reduce or eliminate, for example, the need to use plug-in power converters to provide power to the sensors 210.

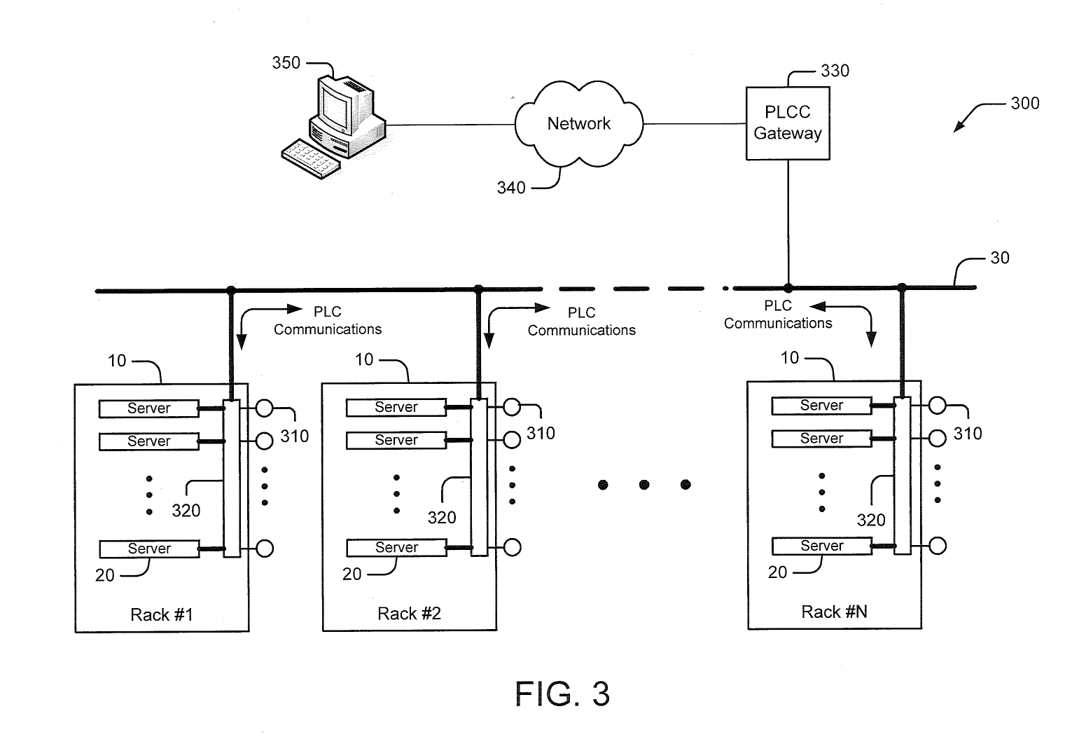

FIG. 3 illustrates a power distribution and communications system 300 for a data center or similar application according to further embodiments. The system 300 includes respective power and communications distribution units 320 positioned at respective equipment racks 10. Each of the power and communications distribution units 320 is configured to provide a power line carrier interface for sensors 310 and to provide power to electronic equipment, e.g., servers 20, in the racks 10 from a power distribution system 30. A PLCC gateway 330 is coupled to the power distribution system 30 and communicates with the power and communications distribution units 320 using power line carrier communications over the power distribution network 30. The PLCC gateway 330 may be configured to communicate with a monitoring device, such as computer 350 executing a monitoring application and coupled to the gateway 330 via a network 340.

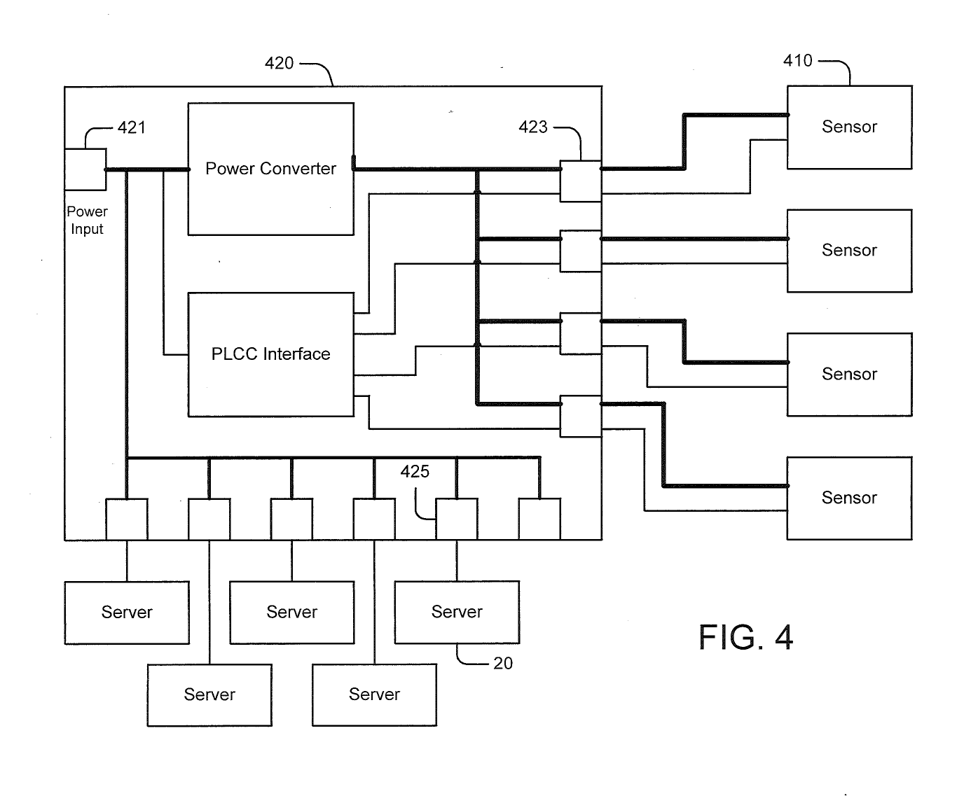

FIG. 4 illustrates a power and communications distribution unit 420 that may be used in the system 300 of FIG. 3. The power and communications distribution unit 420 includes a power input 421 and a plurality of output power connectors 425. The power output connectors 425 may be configured to be coupled to various loads, such as servers 20, in an equipment rack. The power input 421 may be directly connected to the power output connectors 425 and/or intervening switches, power conditioning circuitry or other devices may be coupled between the power input 421 and the power output connectors 425.

The power and communications distribution unit 420 also includes a plurality of communications bus connectors 423, which are configured to be coupled to various sensors 410. The power and communications distribution unit 420 further includes a PLCC interface circuit 422 that is configured to provide an interface between communications over communications busses connected to the communications bus connectors 423 and power line carrier communications over a power distribution network coupled to the power input 421. Along the lines discussed above with reference to FIG. 2, the PLCC interface circuit 422 may simply perform a physical layer conversion or may also provide any of a variety of other functions, such as serving as a network router, bridge or switch, multiplexing or consolidating sensor data received from multiple ones of the sensors 410 and/or diagnostic functions, such as detecting loss of communications with particular ones of the sensors 410 and responsively communicating status information to an end user device over the power distribution network attached to the power input.

The power and communications distribution unit 420 may further include a power converter circuit 424 configured to provide power to at least some of the bus connectors 423 and the connected sensors 410. For example, if the power distribution network coupled to the power input 421 is an AC power distribution network and the bus connectors support powered bus standards, such as power-over-Ethernet (PoE) and/or powered USB, the power converter circuit 424 may include rectifier and/or other power conversion circuitry that generates one ore more appropriate DC power outputs for the bus connectors 423.

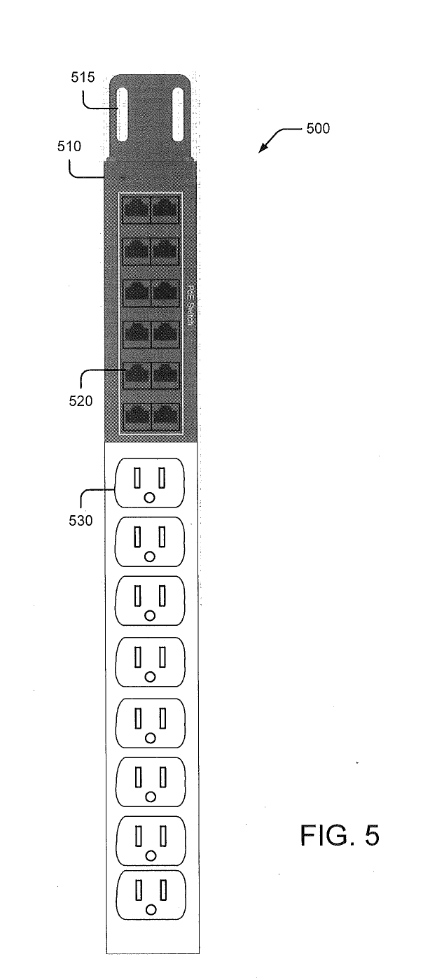

FIG. 5 illustrates an example of a physical configuration for a power and communications distribution unit 500 according to some embodiments. The power and communications distribution unit 500 includes a frame, here including an elongate housing 510 that is configured to be removably mounted in an equipment rack using, for example, mounting holes 515. The power and communications distribution unit 500 further includes a plurality of communications bus connectors, here shown as RJ-45 Ethernet connectors 520 supported by and mounted at a face of the housing 510. It will be appreciated that other types of connectors, such as DB9, DB29 and RJ8, and combinations of various different types of standardized or proprietary connectors, may be used in some embodiments. The connectors 520 are configured to be coupled to sensors positioned in, on or near the equipment rack in which the power and communications distribution unit 500 is mounted. The power and communications distribution unit 500 further includes a plurality of power outputs, here shown as a plurality of single-phase AC sockets 530 supported by and mounted at the same face of the housing 510 as the RJ-45 bus connectors 520. It will be appreciated that FIG. 5 illustrates an example, and that other embodiments may use different configurations, e.g., USB connectors, multiphase power sockets and the like.

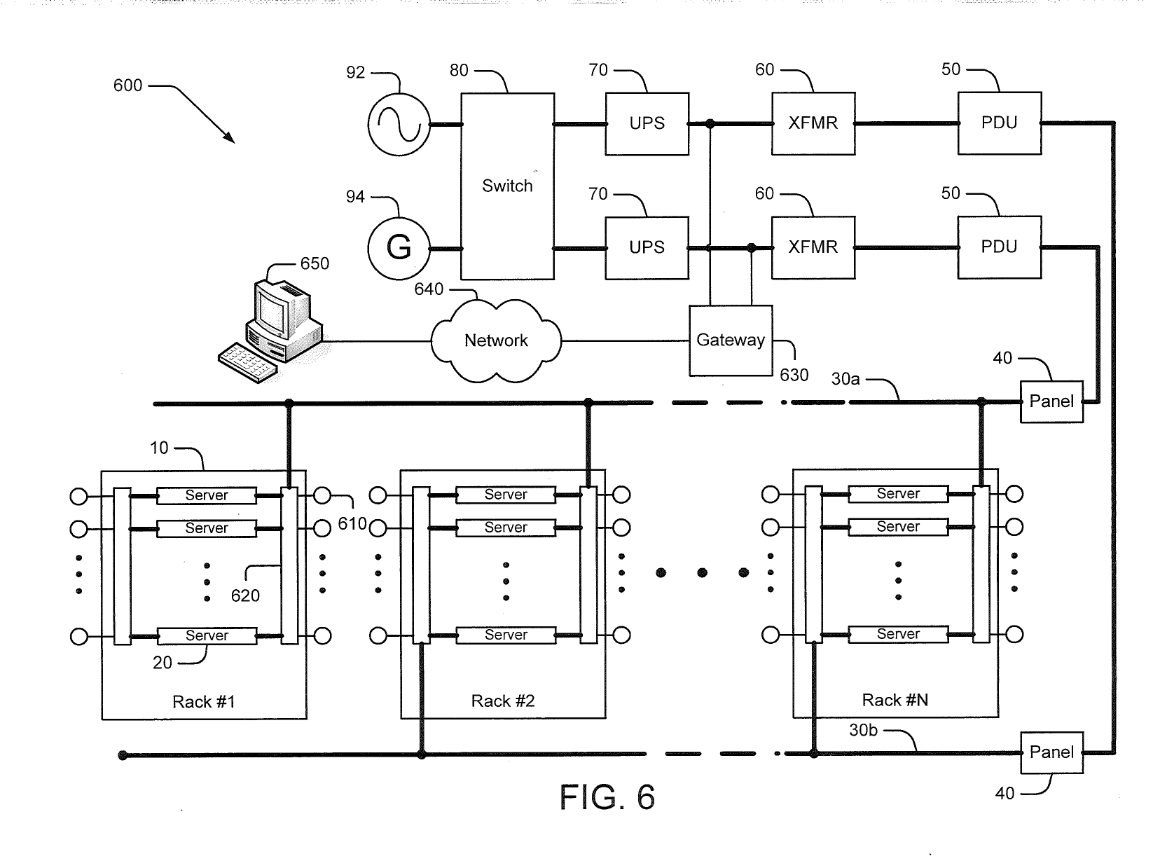

FIG. 6 illustrates a power and communications distribution system 600 for a data center according to further embodiments of the inventive subject matter. The data center includes a plurality of equipment racks 10 housing servers 20 or other types of electronic units. The racks 10 are powered by a redundant power distribution network including first and second power distribution busses 30a, 30b that are connected to respective power distribution chains, each including a distribution panel 40 (e.g., a local circuit breaker panel), a larger power distribution unit (PDU) 50, a step-down transformer 60 and an uninterruptible power supply (UPS) 70. The UPSs 70 may be selectively fed from an AC utility source 92 and a generator 94 via switchgear 80 (e.g., a transfer switch assembly). In some embodiments, the first and second power distribution busses 30a, 30b may be independent, e.g., may be fed from separate utility sources.

Each of the racks 10 has first and second power and communications distribution units 620 mounted therein, with respective ones of the power and communications distribution units 620 in each rack being coupled to respective ones of the power distribution busses 30a, 30b. The power and communications distribution units 620 are connected to sensors 610 positioned in, on or near the respective racks 10, and provide redundant power to equipment modules, e.g., the servers 20, mounted in the racks 10. Each of the power and communications distribution units 620 may be configured to provide power distribution and communications functions along the lines described above with reference to FIGS. 3 and 4, and may have a form factor along the lines described above with reference to FIG. 5. A PLCC gateway 630 is used to connect a monitor device, e.g., a computer 650, to communicate with the sensors 610. Such a monitor device may be directly connected to the PLCC gateway 630 or, as shown, may be connected to the gateway 630 via an intervening network 640. The PLCC gateway 630 may be implemented in one or both of the UPSs 70 and/or in other power distribution system components, such as the PDUs 50.

Some or all of the power system components, e.g., the distribution panels 40, the PDU 50 and/or the UPSs 70, may also be configured to support power line carrier communications. These units may, for example, communicate status information to the monitor computer 650 in addition to the information provided by the sensors 610. Such PLCC capable units may also be configured to communicate with the sensors 610. In some embodiments, a PLCC gateway, such as the gateway 630, may be incorporated into one of these power system components, such as in the PDU 50 and/or the UPSs 70, such that a monitor computer or other monitor device may communicate with the sensors via such an embedded gateway.

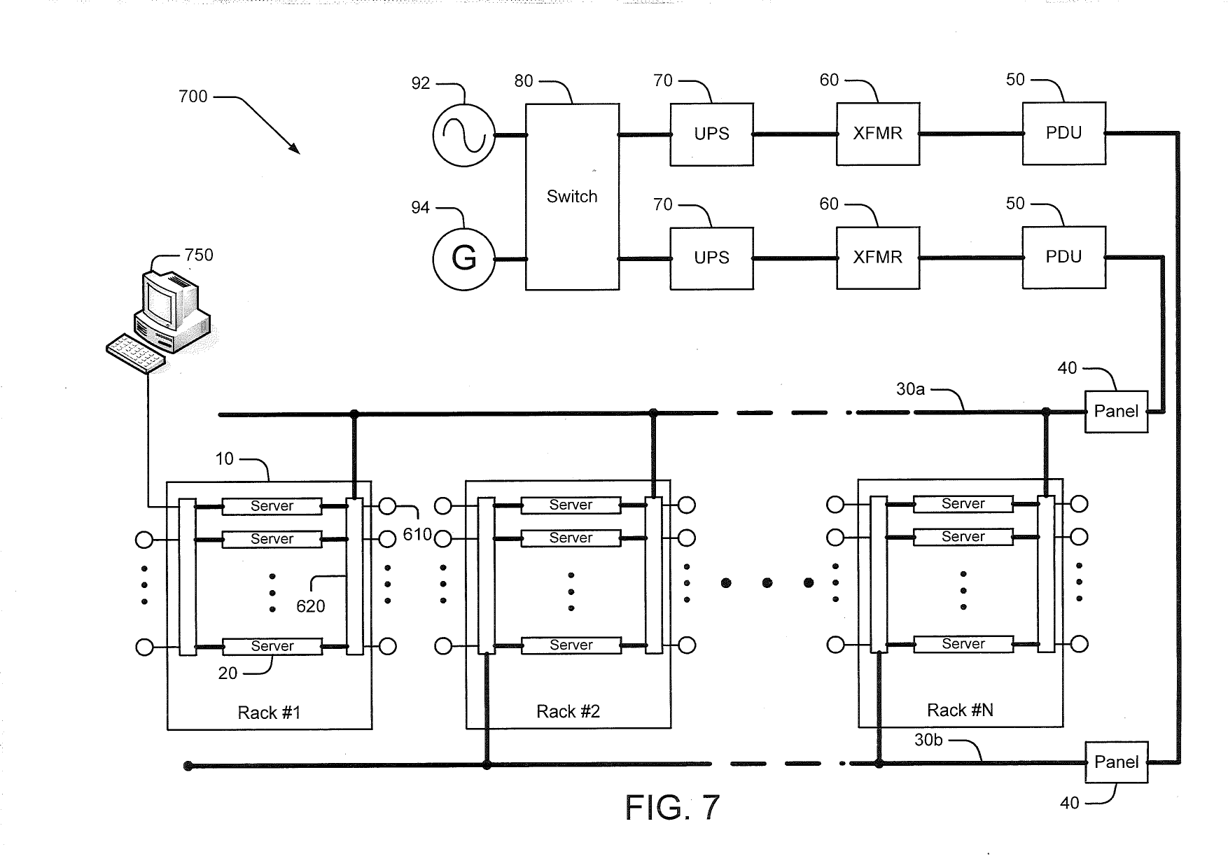

FIG. 7 illustrates power and communications distribution system 700 according to further embodiments. The power system components illustrated in FIG. 7 are the same as those illustrated in FIG. 6, and description thereof will not be repeated. In the system 700, a monitor device, e.g., a computer 750, is coupled to one of the communications bus connectors of one of the power and communications distribution units 620, rather than via a separate PLCC gateway. Such an arrangement may provide flexibility as, for example, maintenance personnel in a large, distributed data center may be able to plug into the network at any particular location to monitor the sensors 610 and/or to communicate with various components of the power distribution system, such as the distribution panels 40, the PDU 50 and/or the UPSs 70. It will be appreciated that the arrangements shown in FIGS. 6 and 7 may be combined, e.g., multiple devices may communicate with the sensors 610 using a PLCC gateway and/or a bus connection via a power and communications distribution unit 620.

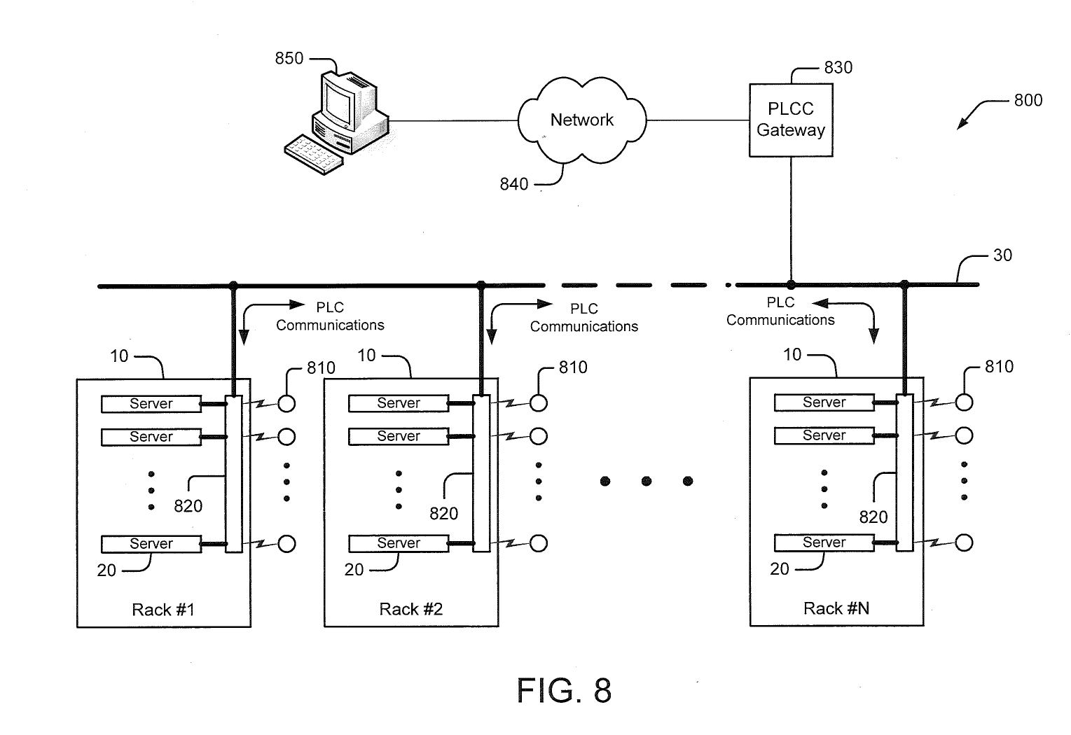

According to further embodiments, a power and communications distribution system may utilize wireless links for sensor interfaces. An example of such a power distribution and communications system 800 for a data center or similar application is illustrated in FIG. 8. The system 800 includes respective power and communications distribution units 820 positioned at respective equipment racks 10. Each of the power and communications distribution units 820 is configured to provide a power line carrier interface for sensors 810 that are wirelessly linked (e.g., via radio or optical links) to the power and communications distribution units 820 and to provide power to electronic equipment, e.g., servers 20, in the racks 10 from a power distribution system 30. The wireless links for the sensors 810 may comprise, for example, radio frequency (RF), light, visible light, infrared and/or ultrasound links, including those used in, but not limited to, wireless area networks, such as, but not limited to, IEEE 802.11 and all its variants (e.g., without limitation, 802.11a; 802,11b; 802.11g), IEEE 802.15 and all its variants (e.g., without limitation, 802.15.1; 802.15.3, 802.15.4), IEEE 802.16 and all its variants, other wireless communication standards (e.g., without limitation, ZigBee™ Alliance standard), HyperLan, DECT, PWT, pager, PCS, Wi-Fi, Bluetooth™, and cellular.

A PLCC gateway 830 is coupled to the power distribution system 30 and communicates with the power and communications distribution units 820 using power line carrier communications over the power distribution network 30. The PLCC gateway 830 may be configured to communicate with a monitoring device, such as computer 850 executing a monitoring application and coupled to the gateway 830 via a network 840.

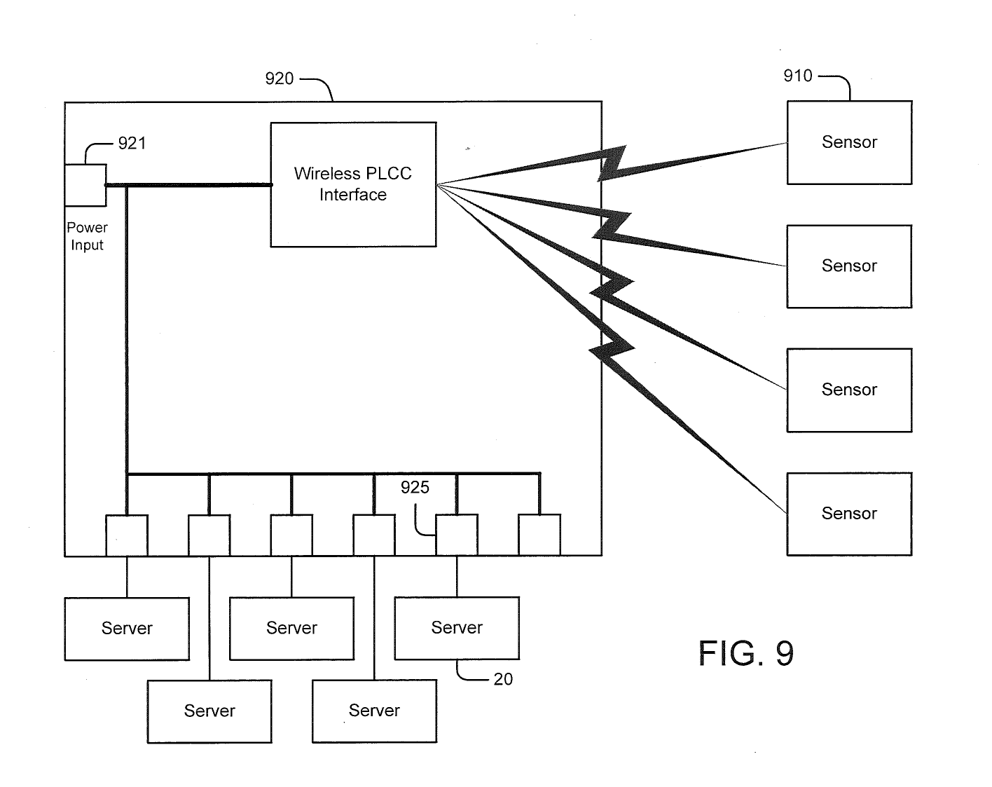

FIG. 9 illustrates a power and communications distribution unit 920 that may be used in the system 800 of FIG. 8. The power and communications distribution unit 920 includes a power input 921 and a plurality of output power connectors 925. The power output connectors 925 may be configured to be coupled to various loads, such as servers 20, in an equipment rack. The power input 921 may be directly connected to the power output connectors 925 and/or intervening switches, power conditioning circuitry or other devices may be coupled between the power input 921 and the power output connectors 925.

The power and communications distribution unit 920 also includes a wireless PLCC interface circuit 922 that is configured to provide an interface between communications with sensors 910 over wireless (e.g., radio or optical) communications links and power line carrier communications over a power distribution network coupled to the power input 921. The wireless PLCC interface circuit 922 may simply perform a physical layer conversion or may also provide any of a variety of other functions, such as serving as a network router, bridge or switch, multiplexing or consolidating sensor data received from multiple ones of the sensors 910 and/or diagnostic functions, such as detecting loss of communications with particular ones of the sensors 910 and responsively communicating status information to an end user device over the power distribution network attached to the power input.

In further embodiments, communications distribution units with different capabilities along the lines described above with reference to FIGS. 1-9 may be used in combination in an installation, such as a data center. For example, a power and sensor communications distribution system for a data center may include communications distribution units that provide distributed sensor communications (wired and/or wireless), along with units that provide both communications and power distribution functions for sensors and/or other equipment in the data center.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. A sensor communications distribution system comprising:
a plurality of communications distribution units mounted in a plurality of equipment racks, each of the communications distribution units comprising a frame configured to be mounted in an equipment rack, a power bus supported by the frame and coupled to at least one power distribution network and a power line carrier communications interface circuit coupled to a plurality of sensors and to the power bus.

2. The system of claim 1, further comprising a plurality of communications bus connectors supported by the frame and coupling the power line carrier communications interface circuit to respective ones of the sensors.

3. The system of claim 2, wherein each communications distribution unit further comprises a power converter circuit coupled to the power bus and configured to provide power to power conductors of the communications bus connectors.

4. The system of claim 2, wherein each communications distribution unit further comprises a plurality of power connectors supported by the frame, coupled to the power bus and coupled to power inputs of equipment mounted in the equipment racks.

5. The system of claim 1, wherein the power line carrier communications interface circuit is wirelessly coupled to the plurality of sensors.

6. The system of claim 5, wherein each communications distribution unit further comprises a plurality of power connectors supported by the frame, coupled to the power bus and coupled to power inputs of equipment mounted in the equipment racks.

7. The system of claim 1, further comprising a power line carrier gateway coupled to the at least one power distribution network.

8. The system of claim 7, further comprising a monitor device coupled to the power line carrier gateway.

9. The system of claim 1, further comprising a monitor device coupled to a power line carrier communications interface circuit of one of the communications distribution units.

10. The system of claim 1, wherein each communications distribution unit further comprises a plurality of power connectors supported by the frame, coupled to the power bus and coupled to power inputs of equipment mounted in the equipment racks.

11. A communications distribution unit comprising:
a frame configured to be mounted to an electronic equipment rack;
a plurality of communications bus connectors supported by the frame;
a power bus supported by the frame and configured to be coupled to at least one power distribution network of the equipment rack;
a power line carrier communications interface circuit coupled to the plurality of communications bus connectors and to the power bus; and
a power converter circuit coupled to the power bus and configured to provide power to power conductors of the communications bus connectors.

12. A sensor system comprising respective communications distribution units as claimed in claim 11 mounted in respective electronic equipment racks and coupled to a power distribution bus and a plurality of sensors coupled to communications bus connectors of the communications distribution units.

13. The sensor system of claim 12, further comprising a power line carrier gateway coupled to the power distribution bus and a monitor device coupled to the power line carrier gateway.

14. The sensor system of claim 12, further comprising a monitor device coupled to a communications bus connector of at least one of the communications distribution units.

15. A power and communications distribution unit comprising:
a frame configured to be mounted to an electronic equipment rack;
a plurality of power connectors supported by the frame;
a power bus supported by the frame and electrically coupled to the plurality of power connectors; and
a power line carrier communications interface circuit coupled to the power bus and configured to be coupled to external sensors.

16. The power and communications distribution unit of claim 15, further comprising a plurality of communications bus connectors supported by the frame and wherein the power line carrier communications interface circuit is configured to be coupled to the external sensors via the plurality of communications bus connectors.

17. The power and communications distribution unit of claim 16, further comprising a power converter circuit coupled to the power bus and configured to provide power to power conductors of the communications bus connectors.

18. The power and communications distribution unit of claim 15, wherein the power line carrier communications interface circuit is configured to be wirelessly coupled to the external sensors.

19. The power and communications distribution unit of claim 15, wherein the frame comprises an elongate housing and wherein the power connectors are mounted at a face of the housing.

20. The power and communications distribution unit of claim 19, wherein the housing is configured to be removably attached to an equipment rack.

21. A system comprising respective power and communications distribution units as claimed in claim 15 mounted in respective electronic equipment racks and coupled to a power line carrier gateway via a power distribution network and a plurality of sensors coupled to the power and communications distribution units.
